(19) United States
(12) Patent Application Publication
(10) Pub. No.: US 2006/0005264 A1
(43) Pub. Date: Jan. 5, 2006

(54) Computer security system

(76) Inventors: H.M. Chris Lin, Hsinchu City (TW); Peng-Hua Wang, Changhua City (TW); Hunter Chen, Taipei City (TW)

Correspondence Address: RAYMOND Y. CHAN, 108 N. YNEZ AVE., SUITE 128, MONTEREY PARK, CA, 91754, US

(21) Appl. No.: 10/866,056

(22) Filed: Jun. 10, 2004

(51) Int. Cl. G06F 1/26

(52) U.S. Cl. 726/35

(57) ABSTRACT

A computer security system for protecting a portable computer unit such as personal computers, laptops and PDAs from being taken away or moved by anyone other than the owner when such computer units are being used in the public, comprising a control unit, a motion detector and an alarm device, wherein the motion detector detects any unauthorized movement of the portable computer and generates a motion signal to the control unit. The control unit, which connects to the portable computer unit, activates the alarm device when a motion signal is received from the motion detector, such that an alert signal is produced by the alarm device to scare away anyone who wishes to steal or move the computer and to alert the owner and people around the portable computer unit when the portable computer unit is moved in an unauthorized manner.

### BACKGROUND OF THE PRESENT INVENTION

1. Field of Invention

The present invention relates to a computer security system, and more particularly to a portable computer security system for protecting a portable computer unit such as personal computers, laptops and PDAs from being taken away or moved by anyone other than the owner.

2. Description of Related Arts

Nowadays, as people heavily rely on their computers, portable computer devices such as laptops and PDAs (personal data assistants) become more and more popular, important and indispensable. People carry such devices around and use them as their organizers, address books, document or work storages, as well as their work stations, and as a result, a lot of important information is stored in such portable computer devices. Hence, most people cannot afford to loose such devices, especially when such devices are fairly costly.

However, the fact that such portable computer devices are so useful, convenient and easy to carry around creates the greatest drawback of attracting thieves to simply carry them away when the owners are not paying attention when such devices are being used in the public.

Furthermore, most owners would find it a hassle to have to shut down the systems and put such devices away just to get a cup of coffee or go to the restroom, or they would run into the risk of loosing the devices.

Seeing the need to protect such important personal property and to provide maximum convenience, a lot of software, hardware, as well as physical locks are developed to help protecting such devices. Software locks are essentially password locks locking the computer operating system, such that unauthorized person cannot access the data in the computer; hardware locks such as USB keys prevents the operation of the system from being used without the presence of the key; physical locks fix the personal computer on one location.

The above mentioned protections, however, can only act as passive protections which protect the data in the computer system once the computer device has been taken away and are therefore not effective enough in protecting the computer devices from being carried away. Software locks and hardware locks can only prevent an unauthorized person from accessing the data in the system, but cannot prevent the personal computer device from being taken away in an unauthorized manner. As for physical chain locks, indeed, they can help keeping the computer devices in one place, however, they can easily be tampered with and or dismantled, providing insufficient protection.

As a result, an active portable computer security system that can offer full protection to computer devices before or after being carried away has to be developed.

### SUMMARY OF THE PRESENT INVENTION

A main object of the present invention is to provide a computer security system, and more particularly to a portable computer security system for protecting a portable computer unit such as personal computers, laptops and PDAs from any unauthorized movement, such as being taken away by anyone other than the owner, wherein the computer security system comprises a control unit adapted for communicatively connecting with a portable computer unit, a motion detector electrically connected with the control unit, wherein the motion detector is adapted for generating a motion signal to the control unit in response to a motion of the portable computer unit and an alarm device electrically connected to the control unit, wherein the alarm device is activated to generate an alert signal when the control unit receives the motion signal from the motion detector for actively safeguarding the portable computer unit against unauthorized movement thereof, so as to alert the owner when the computer unit is moved in an unauthorized manner and scare away unauthorized persons trying to carry away the computer unit.

Another object of the present invention is to provide a computer security system that generates the alert signal simply when the computer unit is being moved in an unauthorized manner, providing an active security device attracting attention from people, as oppose to the passive security device provided by conventional software and hardware locks.

Another object of the present invention is to provide a computer security system further comprises a locking controller, which is electrically connected with the alarm device, comprising a universal connector for adapting with the portable computer unit and an activating device the alarm device to generate the alert signal when the universal connector is disconnected with respect to the portable computer unit in an unauthorized manner, such that the computer security system is easily activated and to prevent intentional detachment of the computer security system from the computer unit.

Another object of the present invention is to provide a computer security system that can be built in with the computer unit such that no extra burden is laid on the owner.

Another object of the present invention is to provide a computer security system that can be externally connected with the computer unit, such that the computer security system can be applied to different computer units as required by the owner.

Another object of the present invention is to provide a computer security system that is compact and small, such that it is convenient to be carried around and easy to store, along with other accessories.

Another object of the present invention is to provide a computer security system wherein once the security system is activated, the security system remains activated even when the computer unit is shut down.

Another object to the present invention is to provide a computer security system requiring a password to deactivate once activated, wherein the password, along with other properties of the computer security system can be customized for the owner according to the owner's preference.

Another object of the present invention is to provide a computer security system wherein the movement detector can also be manually activated by pressing an activating key on the computer unit or the computer security system such that the computer security system is usable on all operating systems.

Another object of the present invention is to provide a computer security system, wherein the activating device of the locking controller is in a removable memory.

Another object of the present invention is to provide a computer security system, wherein a security system power required by the computer security system is provided by the computer unit.

Another object of the present invention is to provide a computer security system further comprising a power control circuit electrically connected to the computer security system, providing the security system power to the computer security system when the computer unit is shut down.

Another object of the present invention is to provide a computer security system, the configuration of which is simple and inexpensive, such that a useful, cheap and reliable security system is provided to the computer units.

Accordingly, in order to accomplish the above objects, the present invention provides a computer security system, comprising:

a control unit adapted for communicatively connecting with the portable computer unit;

a motion detector electrically connected to the control unit, wherein the motion detector is adapted for generating a motion signal to the control unit in response to a motion of the portable computer unit; and

an alarm device electrically connected with the control unit, wherein the alarm device is activated to generate an alert signal when the control unit receives the motion signal from the motion detector for actively safeguarding the portable computer unit against unauthorized movement thereof.

### BRIEF DESCRIPTION OF THE DRAWINGS

FIG. 1 is a perspective view of a computer security system according to a preferred embodiment of the present invention.

FIG. 2 is a flow diagram of the computer security system according to the above preferred embodiment of the present invention.

FIG. 3 is a flow diagram of the computer security system according to an alternative embodiment of the present invention.

FIG. 4 is a flow diagram of the method for actively protecting a portable computer unit according to another alternative embodiment of the present invention.

### DETAILED DESCRIPTION OF THE PREFERRED EMBODIMENT

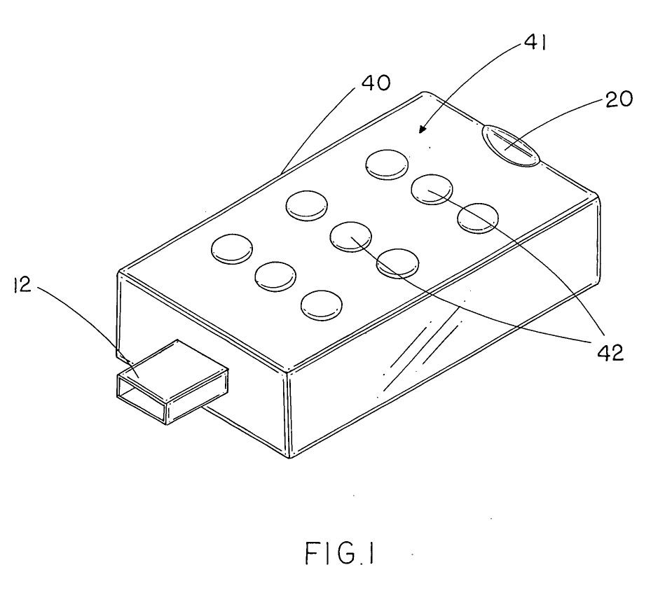

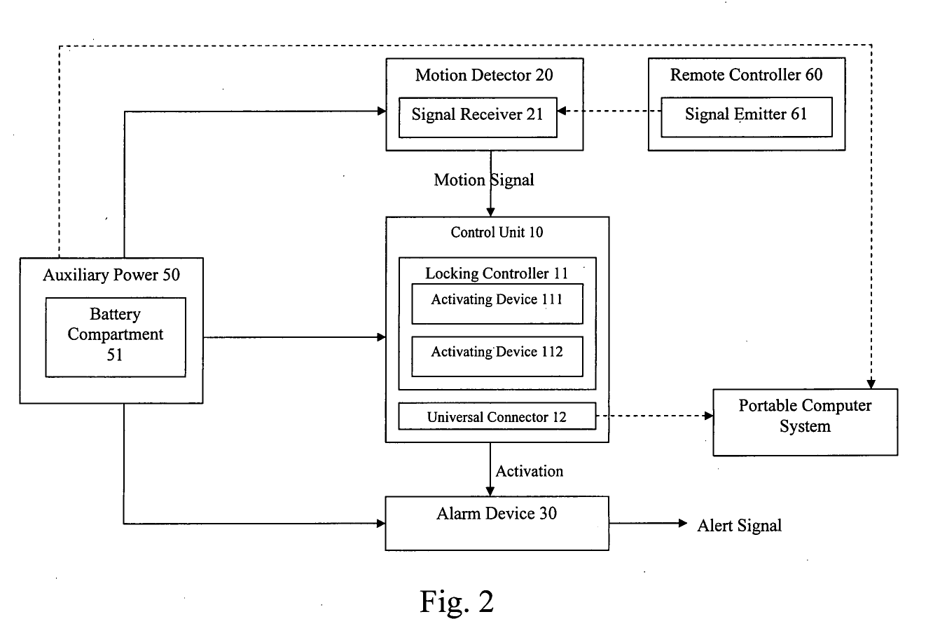

Referring to FIG. 1 and FIG. 2 of the drawings, computer security system for a portable computer unit according to a preferred embodiment of the present invention is illustrated, wherein computer security system comprises a control unit 10, a motion detector 20 and an alarm device 30.

The control unit 10 is adapted for communicatively connecting to the portable computer unit. The motion detector 20 is electrically connected to the control unit 10. The motion detector 20 generates a motion signal to the control unit 10 when a motion of the portable computer unit is detected by the motion detector 20.

The alarm device 30 is electrically connected to the control unit 10. The alarm device 30 is activated to generate an alert signal when the control unit 10 receives the motion signal from the motion detector 20.

Such a computer security system provides an active safeguard to the portable computer unit against any unauthorized physical movement of the portable computer unit, such that an alert is provided to the owner, as well as people around the device, when the computer unit is being moved in an unauthorized manner. It also scares away such unauthorized persons when they try to carry away the computer unit. Such active computer security system attracts attention from people when the computer unit is being tampered with or carried away, which can prevent the lost of such units right from the very beginning, as oppose to conventional passive security devices, which can only protect important information in the computer units after the units have been tampered with or carried away.

The alert signal generated by the alarm device 30 can be in the form of audio signal, lighting effect or a device that can send message to a cell phone or a pager. The alert signal generated by the alarm device 30 can also be a combination of such signals.

In the case where the alert signal is in the form of audio signal, the alarm device 30 comprises a speaker for producing an audio signal as the alert signal when the control unit 20 receives the motion signal from the motion detector 10.

In the case where the alert signal is in the form of a lighting effect, the alarm device 30 comprises a light emitting diode for producing a lighting effect as the alert signal when the control unit 10 receives the motion signal from the motion detector 20.

In the case where the alert signal is in the form of a message sent to a cellphone or a pager, the alarm device 30 comprises a wireless communication unit for wirelessly sending a communication signal as the alert signal when the control unit 10 receives the motion signal from the motion detector 20.

In order to enhance the alert signal produced by the alarm device 30, the alarm device 30 comprises a combination of the speaker, the light emitting diode and the wireless communication unit. The manner of the alert signal produced is controlled by the control unit 10.

For application flexibility, the control unit 10 is able to be applied to the portable computer unit both internally and externally. When applied internally, the control unit 10 of the computer security system is integrated with the portable computer unit so as to provide a computer security system that does not create an accessory to the owner.

However, if the owner wishes to apply the computer security system to more than one portable computer unit, an externally applied computer security system is available. The control unit 10 of the computer security system is connected to the computer unit through connection ports such as USB, PCMCIA or RS232, such that the computer security system is detachable from the portable computer unit, allowing the computer security system to be applied to different computer units.

The motion detector 20 comprises any conventional motion detectors, such as a mercury switch, tilt switch, tilt sensor or an ambient light sensor, a digital camera or an ultrasonic transducer and receiver.

In the case where the motion detector 20 comprises a mercury switch, when the detector or the laptop is moved, the switch changes from on to off or vice versa. The change in the switch is then sensed by the control unit 10, which activates the alarm device 30 to generate the alert signal.

In the case where the motion detector 20 comprises an ambient light sensor, when the laptop is moved, the light entered the sensor changes. The change in the light sensed is then sensed by the control unit 10, which activates the alarm device 30 to generate the alert signal.

In the case where the motion detector 20 comprises a digital camera, when the laptop is moved, the scene captured will change. The change in the scene captured is sensed by the control unit 10, which activates the alarm device 30 to generate the alert signal.

In the case where the motion detector 20 comprises an ultrasonic transducer and receiver, when the laptop is moved, the echo received by the receiver changes. The change in the received echo is sensed by the control unit 10, which activates the alarm device 30 to generate the alert signal.

In order to enhance the motion detection of the motion detector 20, the motion detector 20 comprises a combination of the mercury switch, tilt switch, tilt sensor, the ambient light sensor, the digital camera and the ultrasonic transducer and receiver In order to avoid the computer security system from being detached from the portable computer unit in an unauthorized manner, the control unit 10 comprises a locking controller 11, which is electrically connected to the alarm device 30, wherein the locking controller 11 comprises a universal connector 12 for adapting with the portable computer unit and an activating device 111 activating the alarm device 30 to generate the alert signal when the universal connector 12 is disconnected in an unauthorized manner.

Such activating device 111 of the locking controller 11 can be software installed in the portable computer unit.

For application flexibility, the activating device 111 further comprises a remote controller 60 in order to further enhance the flexibility of the computer security system. By providing this flexibility, the owner will be able to activate or deactivate the locking controller 10 by the remote controller 60. The remote controller 60 comprises a signal emitter 61 emitting a remote control signal to the motion detector 20. When the owner would like to activate the security system, he or she may enable the motion detector 20 to start detecting any movement of the portable computer unit by remote controller 60. The motion detector 20 further comprises a signal receiver 21 receiving the remote control signal emitted by the signal emitter 61 of the remote controller 60. When the owner would like to deactivate the security system, he or she may also disable the motion detector 20 by remote controller 60. In brief, the owner has the flexibility of choosing whether or not to activate or deactivate the security system by the remote controller 60.

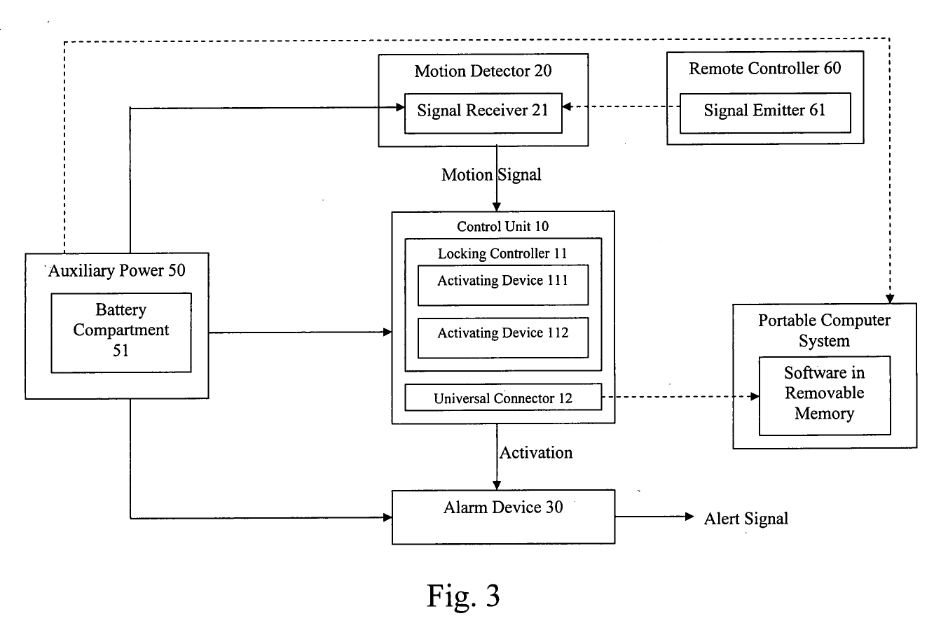

Referring to FIG. 3 of the drawings, according to an alternative embodiment of the present invention, the activating device 111 of the locking controller 11 can be software written on a portable memory, such as a disc or a CD-ROM or a permanent memory, such as BIOS. The owner has the flexibility of choosing whether or not to install the software into the portable computer unit, depending on the memory status of the portable computer unit.

Once the universal connector 12 in connection with the portable computer unit, the activating device 111 also enable the motion detector 20 to start detecting any movement of the portable computer unit. The detection of the motion detector 20 remains activated even when the portable computer unit is accidentally shut down due to reasons such as battery running out or system failure.

When the computer security system is applied externally, a portable compact housing 40 is provided to receive the control unit 10, the motion detector 20 and the alarm device 30 such that an external casing is formed to facilitate the detachable connection of the motion detector 20 with the portable computer unit such that the portability of the computer security system is enhanced. The portable compact housing 40 also acts as a protection to the control unit 10, the motion detector 20 and the alarm device 30, so as to avoid easy tempered with or accidental damage.

Once the computer security system is activated, in order to deactivate the computer security system once activated, as well as deactivating the alarm device once it is activated, the locking controller 11 further comprises a deactivating device 112. Such deactivating device 112 can be a preset password is to be inputted. The password can be inputted through the key pad of the portable computer device.

To allow a user to input the preset password directly through the computer security system, a plurality of keys 42, each of which is electrically connected to the control unit 10, is provided on an interaction surface 41 of the portable compact housing 40.

In order to enhance the flexibility of the computer security system, the preset password is allowed to be preset, customized and changed according to the preference of the user, such that each user can create his own easy-to-remember password.

In order to further enhance the flexibility of the computer security system, the motion detector 20 further comprises a motion relay having a present motion intensity. When a motion intensity of the motion of the portable computer unit is greater than the preset motion intensity, the alarm device is activated to generate the alert signal. The motion with a motion intensity of the portable computer unit smaller than the present motion intensity will not activated the alarm device to generate the alert signal.

The preset motion intensity is preset by the owner of the computer security system, such that the owner can adjust the preset motion intensity to tolerate a desired motion intensity of the motion of the portable computer unit and will not trigger the alarm device 30. By providing this flexibility, the owner will be able to make limited degree of movement to the portable computer unit, such as accidentally moving it while inputting the password, without triggering the alarm device 30 to generate the alert signal.

When the portable computer unit is turned on, a power required by the computer security system is provided by a power source of the portable computer unit. However, according to the preferred embodiment of the present invention, the computer security system further comprises an auxiliary power 50 electrically connected to the motion detector 20 and the alarm device 30, forming a complete circuit with the control unit 10, the motion detector 20 and the alarm device 30, such that when the portable computer unit is switched off, the power required by the computer security system is provided by the auxiliary power 50.

The auxiliary power 50 further comprises a battery compartment 51 for receiving a battery which supplies the power required by the computer security system, such that when the power source is of the portable computer unit is accidentally or intentionally cut off, the computer security system continues to operate. This arrangement will not only provide maximum reliability of the computer security to the user but also limit the use of the battery to a minimum, such that the user does not have to worry about paying extra money to operate the computer security device.

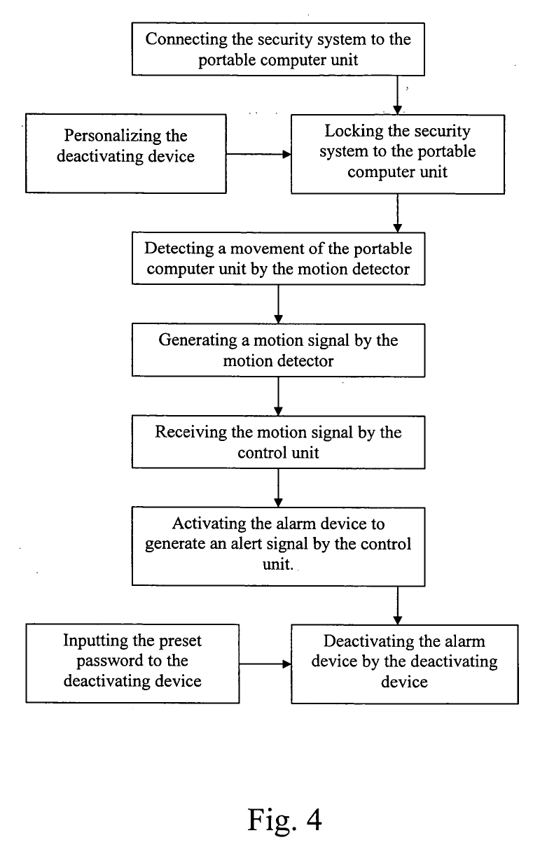

FIG. 4 of the drawings illustrates another alternative embodiment of the present invention, wherein a method for actively protecting a portable computer unit by a computer security system comprises a control unit, a motion detector and an alarm device is disclosed, wherein the method comprises the steps of detecting a movement of the portable computer unit by the motion detector, generating a motion signal by the motion detector when the movement of the portable computer unit is detected, receiving the motion signal by the control unit and activating the alarm device to generate an alert signal by the control unit.

The computer security system as mentioned above is one that is in-built into the portable computer. The computer security system is also capable to be detachable from the portable computer. When the computer security system is one which is detachable from the portable computer, the method further comprises a step of connecting the security system to the portable computer unit, such that the computer security system can detect the movement of the portable computer unit.

It further comprises a step of locking the security system to the portable computer unit, such that when the security system is detached from the portable computer unit in an unauthorized manner, the activating device activates the alarm device to generate the alert signal.

After the alarm device is activated by the activating device to generate the alert signal, in order to deactivate the alert signal by the owner of the portable computer, the method further comprises a step of deactivating the alarm device by the deactivating device.

The step of locking of the security system to the portable computer and the step of deactivating the alarm device is allowed to be controlled by a remote controller.

In order to allow the owner of the portable computer to deactivate the alarm device, the deactivating device has first to be personalized by the owner before the security system is in use. The deactivating device is personalized by providing a preset password to the deactivating device.

When the alert signal is to be deactivated by the owner, the owner has to input the preset password to the deactivating device. When an incorrect password is being inputted to into the deactivating device, the alert signal will not be deactivated.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A computer security system for a portable computer unit, comprising:
a control unit adapted for communicatively connecting with the portable computer unit;
a motion detector, electrically connected to said control unit, generates a motion signal to said control unit in response to a motion of said portable computer unit; and
an alarm device, electrically connected with said control unit, being activated to generate an alert signal when said control unit receives said motion signal from said motion detector for actively attracting attention, so as to safeguard said portable computer unit against unauthorized movement thereof.

2. The computer security system, as recited in claim 1, wherein said control unit comprises a locking controller which is electrically connected to said alarm device and comprises a universal connector for adapting with said portable computer unit and an activating device activating said alarm device to generate said alert signal when said universal connector is disconnected with respect to said portable computer unit in an unauthorized manner.

3. The computer security system, as recited in claim 2, wherein the computer security system is integrally formed in said portable computer unit so as to provide a security system that is permanently installed in said portable computer unit.

4. The computer security system, as recited in claim 2, further comprising a portable compact housing receiving said control unit, motion detector, and said alarm device therein such that said compact housing forms as an external casing for detachably connecting said motion detector with said portable computer unit so as to enhance a portability and applicability of said computer security system.

5. The computer security system, as recited in claim 1, wherein said motion detector comprises a motion relay having a preset motion intensity arranged in such a manner that said alarm device is activated by said control unit to generate said alert signal when a motion intensity of said motion of said portable computer unit is greater than said preset motion intensity.

6. The computer security system, as recited in claim 4, wherein said motion detector comprises a motion relay having a preset motion intensity arranged in such a manner that said alarm device is activated by said control unit to generate said alert signal when a motion intensity of said motion of said portable computer unit is greater than said preset motion intensity.

7. The computer security system, as recited in claim 6, wherein said preset motion intensity is preset by a user so as to allow said control unit to tolerate said motion of said motion intensity less than said preset motion intensity.

8. The computer security system, as recited in claim 7, wherein said locking controller further comprises a deactivating device deactivating said computer security system and said alarm device.

9. The computer security system, as recited in claim 8, wherein said deactivating device is a preset password inputted to said control unit of said computer security system, wherein said preset password is preset by said user.

10. The computer security system, as recited in claim 9, wherein said activating device is in a removable memory.

11. The computer security system, as recited in claim 4, wherein a plurality of keys are provided on said interaction surface of said portable compact housing, wherein each of said keys is electrically connected to said control unit allowing said user to control said control unit, as well as input said preset password.

12. The computer security system, as recited in claim 1, further comprising an auxiliary power electrically connected to said motion detector and said alarm device, forming a complete circuit to provide a power required by said computer security system when said portable computer is turned off.

13. The computer security system, as recited in claim 12, wherein said auxiliary power comprises a battery compartment for receiving a battery.

14. The computer security system, as recited in claim 13, wherein said motion detector comprises a mercury switch.

15. The computer security system, as recited in claim 13, wherein said motion detector comprises an ambient light sensor.

16. The computer security system, as recited in claim 13, wherein said motion detector comprises a digital camera.

17. The computer security system, as recited in claim 13, wherein said motion detector comprises an ultrasonic transducer and an ultrasonic receiver.

18. The computer security system, as recited in claim 13, wherein said alarm device comprises a light emitting diode generating a lighting effect as said alert signal.

19. The computer security system, as recited in claim 13, wherein said alarm device comprises a speaker to generate an audio signal as said alert signal.

20. The computer security system, as recited in claim 13, wherein said alarm device comprises a wireless communication unit electrically connected with said control unit, wherein said wireless communication unit is activated for wirelessly sending a communication signal when said control unit receives said motion signal from said motion detector.

21. The computer security system, as recited in claim 1, further comprises a remote controller controlling said motion detector, wherein said remote controller comprises a signal emitter adapted for emitting a remote control signal, wherein said motion detector further comprises a signal receiver adapted for receiving said remote control signal emitted by said signal emitter.

22. The computer security system, as recited in claim 20, further comprises a remote controller controlling said motion detector, wherein said remote controller comprises a signal emitter adapted for emitting a remote control signal, wherein said motion detector further comprises a signal receiver adapted for receiving said remote control signal emitted by said signal emitter.

23. A method for actively protecting a portable computer unit by a computer security system comprises a control unit, a motion detector and an alarm device, comprising the steps of:
(a) detecting a movement of the portable computer unit by the motion detector;
(b) generating a motion signal by the motion detector when said movement of the portable computer unit is detected;
(c) receiving said motion signal by the control unit; and
(d) activating the alarm device to generate an alert signal by the control unit.

24. The method, as recited in claim 23, further comprises the steps of:
(e) connecting the security system to the portable computer unit; and
(f) locking the security system to the portable computer unit by a locking controller having an activating device and a deactivating device, in such a manner that when the security system is detached from the portable computer unit in an unauthorized manner, said activating device activates the alarm device to generate said alert signal.

25. The method, as recited in claim 23, further comprises a step of:
(g) deactivating the alarm device by said deactivating device.

26. The method, as recited in claim 25, wherein said step (f) and said step (g) is controlled by a remote controller.

27. The method, as recited in claim 26, wherein said step (f) further comprises the steps of:
(f1) personalizing said deactivating device by providing a preset password.

28. The method, as recited in claim 27, wherein said step (g) is inputting said preset password to said deactivating device.
